(19) United States
(12) Patent Application Publication
(10) Pub. No.: US 2008/0042444 A1
(43) Pub. Date: Feb. 21, 2008

(54) Carriage wheel ocean turbine

(76) Inventor: Timothy Ronald Johnson, Riverview, FL (US)

Correspondence Address: Timothy R. Johnson, 13221 Boyette Rd., Riverview, FL, 33569, US

(21) Appl. No.: 11/823,292

(22) Filed: Jun. 27, 2007

Related U.S. Application Data
(60) Provisional application No. 60/818,618, filed on Jul. 5, 2006.

(51) Int. Cl. F03B 13/10

(52) U.S. Cl. 290/54; 415/4.3

(57) ABSTRACT

A turbine wheel on a horizontal axis is constructed on a network of cables radially and circumferentially connected and supported centrifugally by a ring with a friction-reduction method to permit turning within said ring. The ring structure is composed of buoyancy-controlled modules to allow construction of extremely large systems deployable in ocean depths. Electrical equipment can be variously attached for generation of power.

### CROSS-REFERENCE TO RELATED APPLICATIONS

This application claims the benefit of PPA Ser. No. 60/818,618, filed 2006 Jul. 5 by the present inventor, which is incorporated by reference.

### BACKGROUND

1. Field of Invention

This invention relates to fluid current motors deployable in ocean currents for power generation. There is a vast untapped supply of useful energy in the regular movement of the Earth's oceans. We have yet to develop any significant portion of it. This is due to the hostility of the ocean depths to us and our machinery generally. Conquest of this realm and the harvest of its ever-renewing energies is an ancient dream. Recent developments in technology have impelled us to think it is possible. The driving needs of our civilization and the threat posed to it by the increasingly difficult task of meeting those needs with the non-renewable sources on which we now rely have set the stage for a major effort. The moon did not refuse man's footsteps, nor will the ocean.

Both the scale of the energy supply and the scale of the need call out for something larger than the ordinary. Since seeing a Popular Mechanics magazine cover with a rendering of a huge turbine being towed to sea by tiny ships, I have wondered about the reasons why this is not being done. My response has been to devise a system that I believe will work well built large. In its dynamic balance between tension and compression, unnecessary structure has been eliminated. R. Buckminster Fuller and his concept of tensegrity have been a point of beginning for me. My wheel was initially to have been stabilized by his tensegrity sphere. It may be that it would eventually be built large enough to require this. How large the Carriage Wheel Ocean Turbine can be made is an open question. Before it can be answered, we will need systems to permit us far better access and safety in the deep water. My next focus of attention will answer the question of how this giant leap can be accomplished safely.

While I was still grappling with the final form for this invention to take, I visited London. As our cab approached the center of the city, I was astonished to see my invention sitting upright in the middle of the city along the bank of the Thames. The London Eye is actually a fixed wheel with a three-ring trussed circular frame which revolves slowly bearing enclosed sight-seeing capsules. It is borne upon the tensile strength of its radial cable stays, and upon a central hub. The double ring is outside, rather than inside, but the structure is analogous if not identical. The function bears no relationship to my idea, thankfully. Whereas my cable stays slip around the inside of the ring in unison, theirs are fixed in place, and the entire structure rotates twice an hour. It carries 32 capsules weighing 10 tonnes each, plus 800 passengers at any time. At 135 meters in diameter, I offer its analogous structure as evidence that my plan is viable at this size.

2. Prior Art

Most previous underwater turbines have relied on fixed or extendable blades. While these designs function well, they limit the size and therefore the power of the dynamo to be turned. Various aspects of the present invention have been claimed before in earlier patents. None of these has so combined the advantages of these aspects to allow enlargement of the machine to such a great extent as does the Carriage Wheel Ocean Turbine.

The use of tensile cable to support “elongated strut-vane structures” was utilized in U.S. Pat. No. 4,095,918, (1978) to William J. Mouton and David F. Thompson. Their “Turbine wheel with catenary blades” used a shroud ring rim as the peripheral element, which was “rotatably supported therein on radial and thrust bearings, . . . ”. This arrangement involves cables being pre-formed into a specific shape (relaxed catenary). While elegant and efficient, perhaps, in its intended size range, it is limited in size, and therefore power by the solid shroud ring. Mouton and Thompson use a hydraulic system to control vane angle at the shroud ring. This aspect is extremely similar to the “cat-rigged” boom arrangement in my design in function if not form.

The use of a circular peripheral track with wheels imprisoning the ends of the turbine vanes was described in U.S. Pat. No. 6,629,815 (2003) to Dennis W. Lusk. What Mr. Lusk's design does not provide is angular support to the vane ends since it is a single track in this embodiment. Thus the structural control of blade or vane angle upon the rolling carriage is unavailable. This is unnecessary in his “Peripheral Turbine Support System” because he is depicting only rigid vane structures. Mr. Lusk's system also does not anticipate higher tensile loading of the vane ends than is required for stability of the rigid system. The broad-gauge track and four-corner stability of the Carriage Wheel system allows for angular control under high tension levels. Lusk's system is also an air and not a water turbine.

The use of a rail loop with interlinked “cars” driving a dynamo using either wind or water current is described in U.S. Pat. No. 7,075,191 (2006) to Fred E. Davison. The track in this invention is a monorail type built on ground or sea bottom support posts. The track runs in a loop, but this is depicted as an oval. The vanes are mounted on the cars rigidly and turnably. They are not interconnected except for the connections between the cars. This invention is very different in almost every respect from the Carriage Wheel.

Control of buoyancy in an underwater turbine for power generation is also not unique to the Carriage Wheel. In U.S. Pat. No. 6,806,586 (2004) to Aloys Wobben, his “Apparatus and Method to Convert Marine Current Into Electrical Power” specifies buoyancy control through means of cavities within most of the unit's parts. These cavities are to be filled with gas, as the water is removed, to cause the apparatus to float. There is little description of this method in Mr. Wobben's patent, perhaps because the prior art of buoyancy control lies sufficiently within the public domain. The use of it in a submarine apparatus, especially to a diver or submariner, would be considered obvious.

It is the unique combination of the these prior art factors which allows the Carriage Wheel Ocean Turbine to be limited in its size only by the circular area of a section of the sea within which a current constantly passes in the same direction, and by the maximum depth at which the buoyancy systems of the components can function given the pressure at depth.

### BRIEF DESCRIPTION OF THE DRAWINGS

FIG. 1 shows a view of turbine wheel parallel to axis from up-current side.

FIG. 2 shows a lateral view of a carriage on the track from down-current side.

FIG. 3 shows the view from the wheel interior of a carriage on the track.

FIG. 4 shows a section aft of the forward roller center line of a carriage on track.

FIG. 5 shows a perspective view of a single track segment.

FIG. 6 shows an enlarged partial view of the wheel, with buoyancy control units in place.

FIG. 7 shows the initial embodiment of ocean deployment of the Carriage Wheel Ocean Turbine. The support, anchoring and stay system, as well as dynamo locations are suggested.

### DETAILED DESCRIPTION

### Initial Embodiment

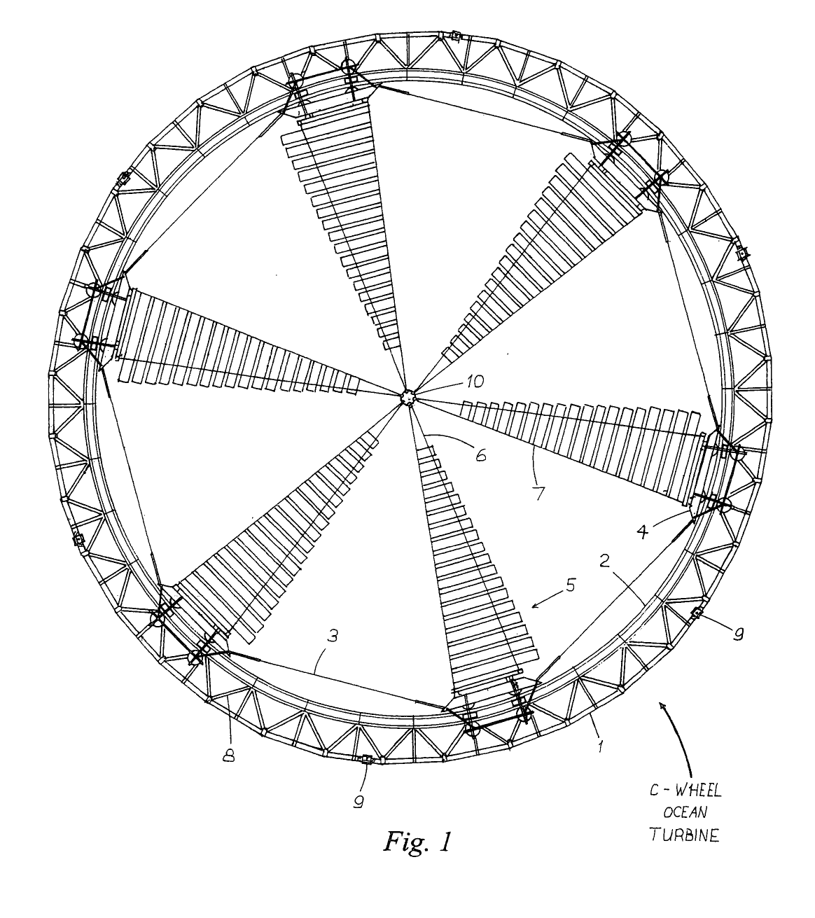

Tracks—FIGS. 1,2,3,4,5

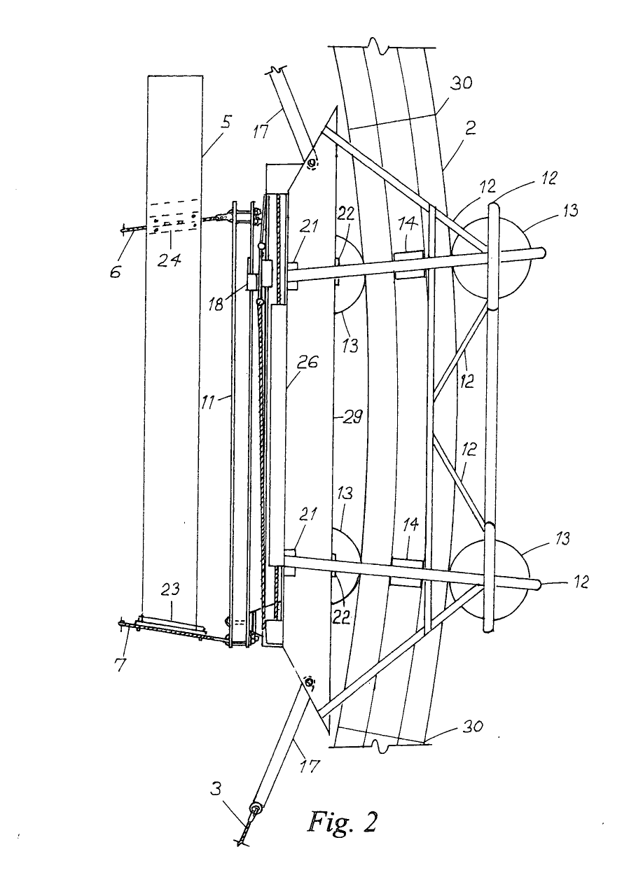

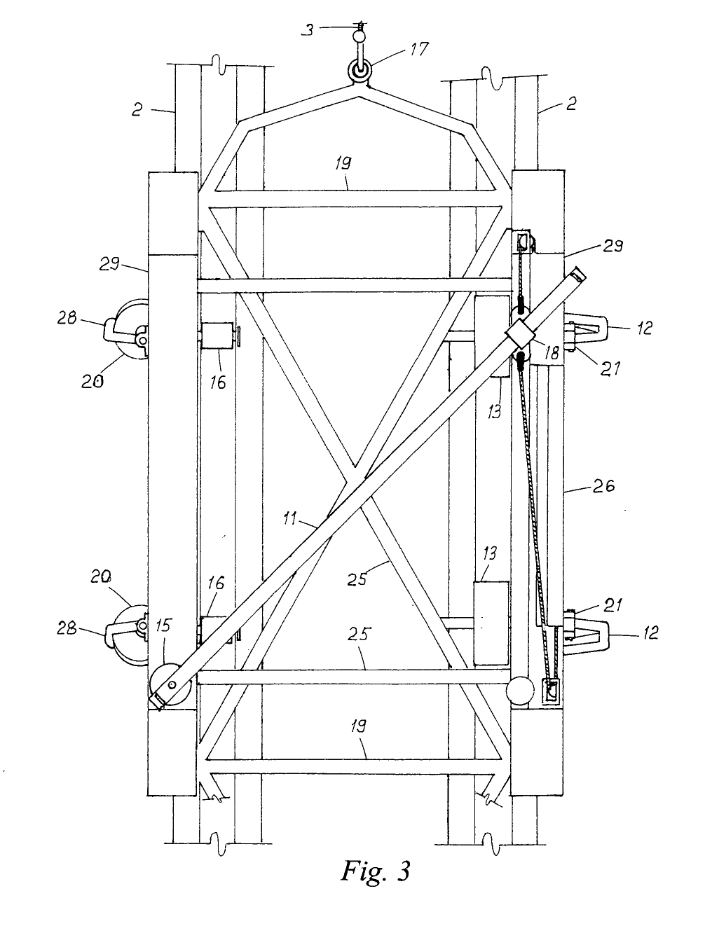

The two tracks are circular, as shown in FIG. 1, and are connected by struts to each other to form a parallel arrangement, as shown in FIG. 2. The twin tracks are both connected to a third ring as shown in FIGS. 1 and 3. They are of octagonal outer sectional contour, with a concentric round space for air or water inside. The tracks will be required to withstand large forces resulting in compression, tension, and shear, but must also provide “roadways” for the wheels and contribute to buoyancy compensation. Reinforced concrete is one material which can meet these requirements.

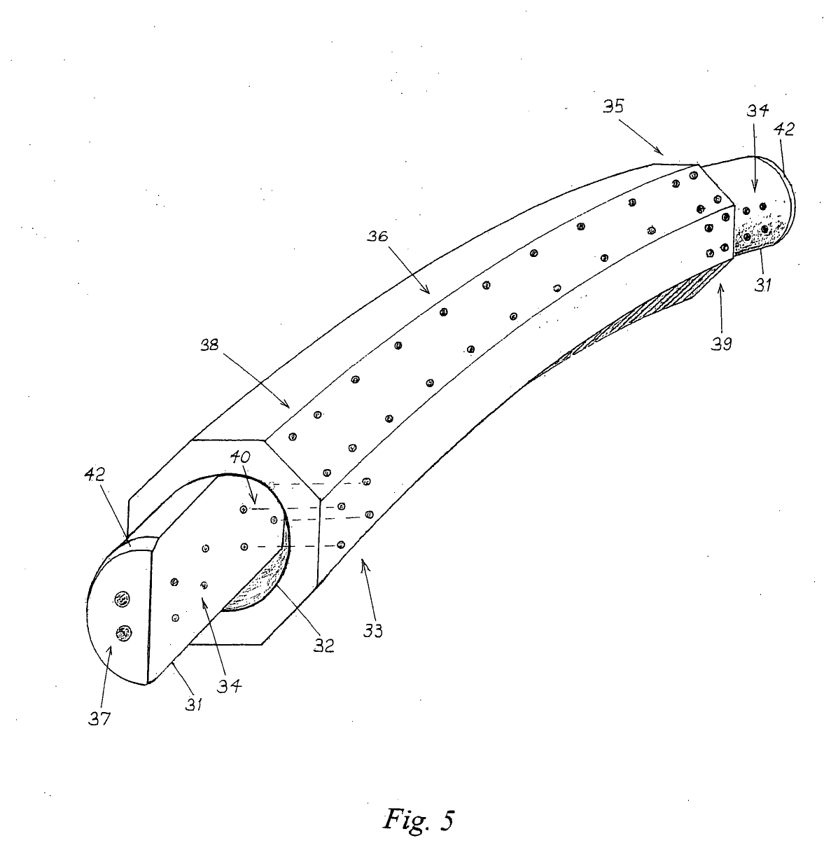

Each of the two tracks is made up of a chosen number of identical pieces. In the example shown, the arc each segment describes comprises a 10 degree sweep from the center of the finished circle, so 36 are required to form each track. The material in the original design is reinforced concrete, using stainless steel throughout the precision-built reinforcement armature with the highest possible strength concrete. Each finished armature is bolted to the parts of a mold and poured under highly controlled conditions. The interior cavity is formed by a round cross-sectioned swept-arc thin wall PVC or other moldable tube (32). Within this is fitted a bladder designed to expand or contract as gas is let in or out. This contains the gas and makes it unnecessary for the cavity to be gas-containing and watertight. It also obviates valves controlling these functions. The cavity can remain open at various points to the surrounding water. The exterior of each track has an octagonal cross-section, and the flats which form the inner and outer “roadways” are ground to eliminate mold lines and perfect concentricity. The end of each track has a split plug (31), making a single solid plug between tack sections through which bolts join two sections. The hermaphrodite ends can be seen clearly in FIG. 5.

Fabrication and Assembly

In the dockside assembly yard, the fully-cured track segments are bolted to the bracing struts and to each other. It would be most efficient to make the largest segment of completed track which the transporting ship's crane equipment is capable of handling. The carriages and their equipment should also be added to the various sub-assemblies prior to loading. Variable controlled buoyancy is the key to being able to position these modules once they arrive at the site. It will be possible to maintain them at shallow depths just below the surface turbulence. This will be achieved by the addition of compressors and high-pressure tanks. These permit compressed air to be let in to all hollow spaces not permanently sealed with buoyant material inside. In a neutrally buoyant condition, little force will be required to hold them in place. The current flow will actually create stability, much as gravity guarantees that things hang down.

At perhaps ten meters underwater, divers can assemble the parts using ship or submarine based power systems. The first segment of each of the two halves of the track circle can be tethered to one of the support masts (54). Temporary restraining cables will maintain correct tension on the outer band and compression on the tracks. As each new section is added, the cables will be “walked” out to maintain the chord from the origin to the last two sections. The turnbuckles (9) in the tension band will be set in a calculated over-tightened position. Then the final opposite ends will be set in proper attitude with tugs. They will then be pulled together as the turnbuckles are loosened. When all connections are made and bolts are tightened, the turnbuckles (9) can again be tightened. If this process proves too difficult, a single, final connection with a straight-prong male (split plug) on either side may be necessary. Rigging the cables (3,6,7) will require precise lengths to be fabricated and set on, and the vanes (5) will be applied when these operations are complete.

Carriages—FIGS. 1,2,3,4

The carriages connect the cables to the central hub with the track system, along which they roll in linkage to each other. They are each comprised of two stainless hulls (29) to which are attached a stainless tube framework (12) on each side which hold the rollers (13,14,16,20) in contact with the tracks. These are sufficiently interconnected and braced as needed. On the inward side is located the attitude control for the cable-supported vane system (26). This is built around a stainless steel boom (11) which has two cables (6,7) one at each end, which extend from the carriage to the center hub. There is one pivoting end (up-current) and one free-traveling, cable-controlled end. This boom resembles that on a cat-rigged sailboat, and the function is similar. The leading edge radial cable serves as the mast. This is stiffer or perhaps higher tensioned than the trailing radial cable. The trailing cable functions to maintain the angle of the vanes (5). The optimal angles and tensions will be determined experimentally. Adjustability will be essential, at least in the prototype. The angle of the boom is controlled by spring-loaded cables. These permit the boom to dump excess current by opening further.

There must be a minimum of three carriages on the wheel in order for the system to work. Six are shown in this embodiment (FIG. 1), but there may be as many as will fit around the wheel. Careful observation of experience will help to determine the optimum number.

The carriages will roll with or without loading due to the wheels which maintain the attitude of the carriage to the track. As shown in FIG. 2, the up-current side has a pair of opening small wheels (16,27) which are heavily sprung. It also has a fixed, unitized wheel support framework (28). The down-current framework (12), though unitized, hinges on the inside outer edge of the square-tube hull (29). It is fixed in use by a set of removable pins or latches (22). Thus the down-current side can be swung out and fixed open. This will facilitate removal of the entire carriage for maintenance or replacement. The two carriage connector cables at each end of the carriage can be removed and attached to a replacement carriage or to each other. All structural members are stainless tubing with connections welded, air-tight and filled with gas or compression-resistant foam. Any material which meets or exceeds the strength, corrosion-resistance, and durability of stainless steel could be substituted.

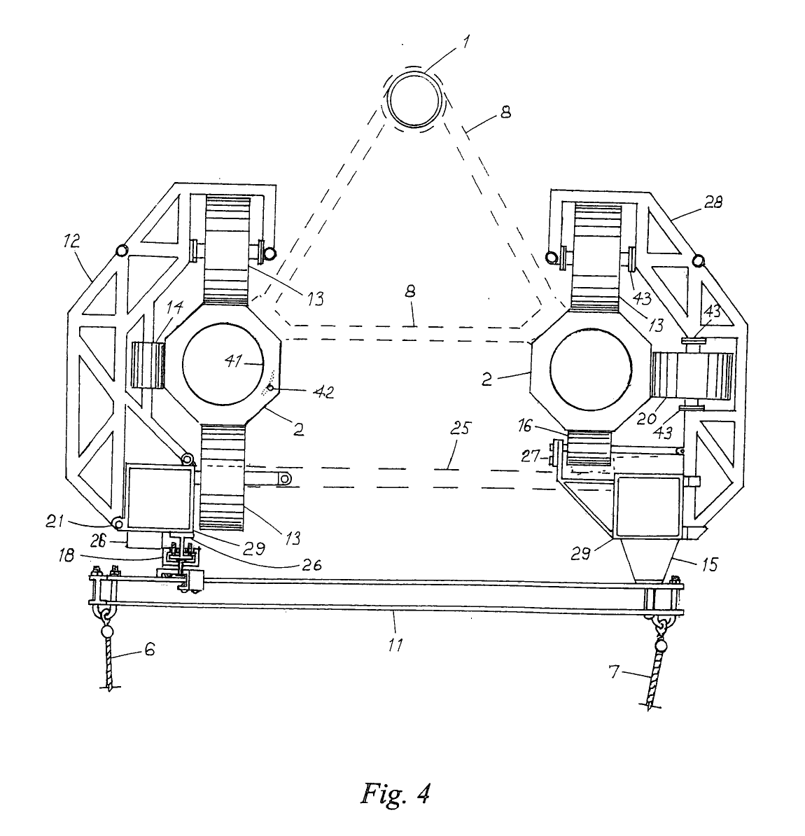

The outer rollers (13) can carry a gear so that their rotation can be used to power systems or charge batteries. One system which will be necessary is the air compressor and its attendant valves and controls. This should be sealed together with a constantly-recharging battery. Air will be carried onboard in pressurized tanks, and the valve-servos will be actuated by remote signal. At the signal, compressed air will be let into bladders in the hulls as water is cleared, increasing buoyancy. The available space on the carriage for buoyancy control systems (45) can be seen in FIG. 4.

Owing to the impact of marine encrustation on buoyancy, it is desirable that an automatic cleaning system be stationed aboard each carriage.

Vanes and Fan Cables—FIGS. 1,2,4,6

As previously mentioned, the carriages (4) are connected together by cables (3) which run between adjacent carriages, and by cables (6,7) from the two ends of each boom (11) run radially to a hub-ring (10) at the center. These radial cables must be adjustable, with each leading-edge cable (7) being of heavier gauge than the after cable (6). Upon these are fastened vanes (5) which are molded to an airfoil-like shape in the initial embodiment. The leading edge is spring-hinged (23) at the cable (7), and the trailing edge, also spring-hinged (24) follows the after cable. Vanes will be neutrally buoyant, rigid, and decreasing in length as they are nearer the center. The vanes are made of fiberglass or graphite fiber/metal composite structure. Spring-loaded hinges will cause excess energy to be dumped if current levels rise sufficiently to damage the equipment. Under optimum conditions, they will remain closed upon the curved surface defined by the radial cables. It is anticipated that a narrower vane profile, or one involving a curvature, might prove more efficient than the original embodiment. The present cable system could support a wide variety of rotor profiles. The boom will hold the carriage end of each cable. The vanes are at approximately a 45 degree angle to the direction of the current passing through. Experimental study of the deflection of the cable/vane system under load will yield the determination of the optimal ambient cable tension, tension ratio, and vane angle. Reduction of the after cable tension can be used as a third “safety” guarding against excessive loading of the structure. The wheel must be designed to function in extreme pressures and a saltwater environment. It seems desirable to this inventor that low-tech, adjustable spring-loading would be a better choice than electronically-controlled servos, hydraulics or other more fragile control systems.

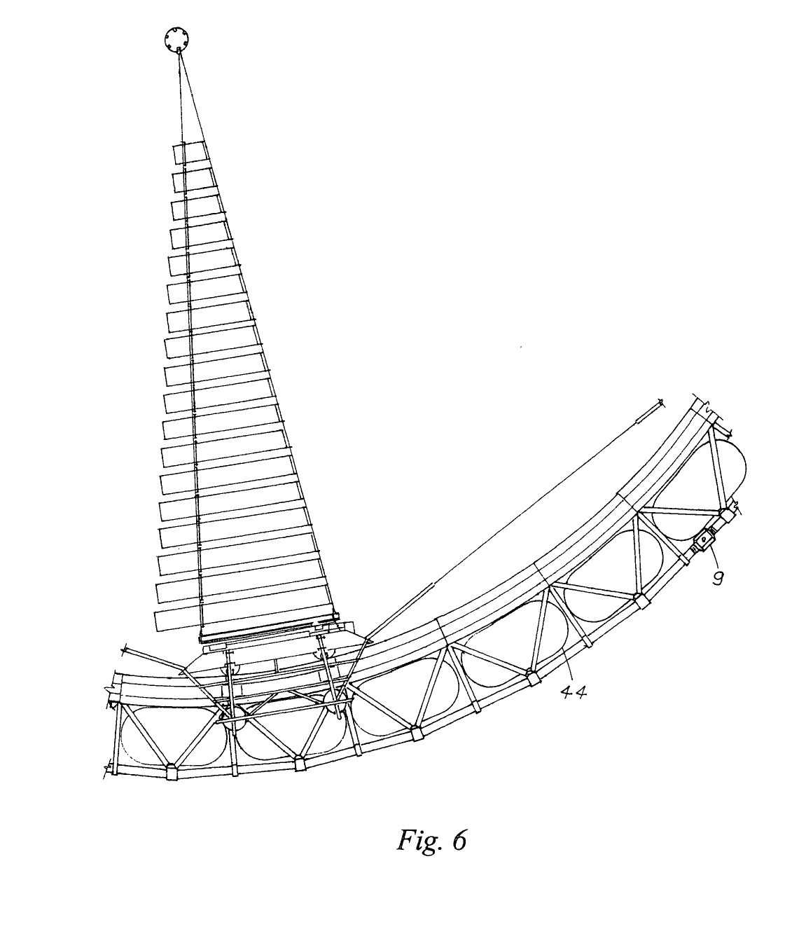

Buoyancy Control—FIGS. 4, 6

Minimization of weight per volume must be compromised in order to obtain sufficient strength of each individual part. Gas will fill all available hollow space within all parts of the system. It is probable that when these engineering considerations are taken into account, the system as a whole will still be negatively buoyant. It will be necessary to have additional onboard compressors, compression tanks and expansion tanks to control buoyancy. These can mount on the carriages as well as in the triangular space within the track assembly. Given extreme depths at which the system might operate, there must be a very high pressure in the compression tanks at the surface in order to obtain expansion at depth. Compression tanks must be extremely robust, while expansion tanks may need to fill the entire available space. To eliminate the air/water interface in the hollow within each track section, a bladder would be useful, providing that pressure can be equalized upon ascent. It may not be feasible to recharge the air or other gas used in the system until it is raised for maintenance. Valves must be capable of passing water only out of the expansion tanks with no gas loss. No patent protection of any of the submarine buoyancy systems is claimed, only the presence of existing technology in this novel use.

Interconnecting Cables and Brakes FIGS. 1, 3

In the depicted embodiment, the interconnecting cables may be wound on drums (19) which are removable at the drum axle interface with the hull ends. A feeding device as in a casting reel would hold the cable in place. This must cause efficient winding on the uptake and prevent backlash. There is also a pair of centering arms supporting an eye through which the cable will pass.

In an alternative embodiment, pre-measured cables will be installed between carriages.

The braking system must, automatically or on command, stop the carriages from turning. They should be actuated by simple mechanical action caused by either excessive or insufficient tension of the carriage interconnection cables, as well as on command from a control system. Thus, in the event of collision with a large object, or other damage requiring stoppage of the rotation of the turbine system, the damage can be limited and not compounded by normal movement. The brakes might be mechanical or hydraulic, but must do the job of stopping rotation. This aspect of the design is incomplete as of this filing.

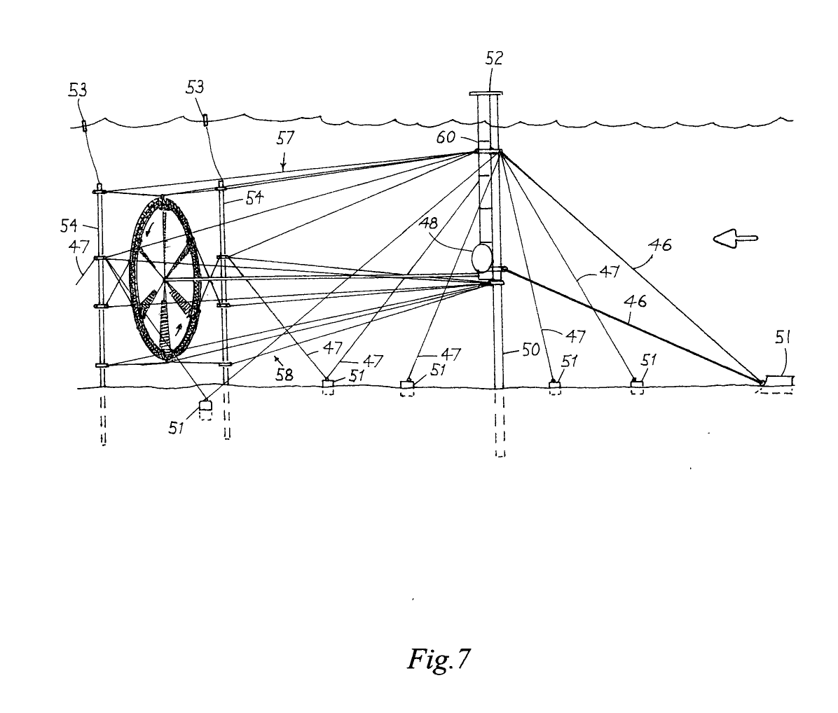

Dynamos—FIG. 7

I will leave this area to those more expert in it than I. It may be that existing designs for submarine dynamos will need to be substantially enlarged.

Tethering—FIG. 7

Initial uses for this invention might involve tethering to vertical mast structures already attached to the seabed, namely, oil drilling towers. These structures pose the additional advantage of a dry environment topside for the main dynamo. The initial embodiment is shown in FIG. 7. The wheel itself will be fixed in position by a number of cables attached to the outer tension ring. All of these should be extendable so that the rig can later be floated and controlled near the surface. The lowest central cable (59) should also be retractable if horizontal operation is desired. Side attachment cables can also be arranged pivotably to permit horizontal powered operation. The arrangement of cables should be such relative to the prevailing current that the wheel will float downstream of its masts. In the case of fluctuating current direction, it may be possible to tether the wheel downstream of a single pivoting attachment, so that the current will always flow at right angles to the wheel. This would call for extreme buoyancy control. The Carriage Wheel will require independent engineering for each potential site, more properly done when the specifics of experience and knowledge of the site can be taken into account.

Tools Necessary to Construct (Not Shown)

To take full advantage of the relative stillness of the ocean below 20 meters of depth, it would be preferable to use tools which are emancipated entirely from the surface. If these can not be obtained (submarines with tugging and robotic arm capacity suitably robust for the size of the work), the largest possible ship with carrying capacity and crane capacity should be utilized. As previously stated, a drilling rig would provide an ideal stable platform for construction as well as tethering. Once in the water, hydraulic clamps and winches would prove useful in assembly. If these can be rendered only slightly negatively buoyant, they could most easily be utilized by divers. Pneumatic wrenches and hammers would prove necessary. Ship-based compressors would also be necessary in order to fill all available air chambers on the structure as it comes together. Separate external flotation bags should also be on hand. Care must always be taken so that valuable tools and parts do not become features of the bottom.

Environmental Concerns

Care of the environment is one of the motivating factors in the creation of this invention. Its impact on its surroundings must be studied carefully to determine what, if any steps need to be taken to alter or add to the equipment to render it safe for the marine ecology. It is common experience that all non-moving parts will soon acquire encrustation and become the habitat of numerous marine creatures. It is my opinion that the structure will not prove dangerous to any life form.

Use of the Carriage Wheel as a Powered Impeller

The origins of this idea involved a plan to convert a power generating system into a powered water mover when conditions required. It was motivated by the approach of numerous hurricanes to our area in 2004. It is thought that the warm surface of the ocean is the chief cause of these tropical storms. Various means of cooling the ocean's surface have been suggested, including towing icebergs and endothermic chemical reactions. It seemed to me rather obvious that the ocean is warm only at and near the surface, and that water from greater depths is always significantly cooler. The simplest solution to cooling the surface, therefore, is a giant system which brings water up from the depths. It occurred to me also that such a system would need to be self-funding. A reversible generator system could accomplish both, provided that it could be rotated 90 degrees to a horizontal plane. My original thought called for a second ring to be maintained in a horizontal position outside the tension band which would contain pivot points, and a third ring outside of that to positively control the pivoting movement. In an extremely large system, bracing could be provided by a tensegrity sphere (R. Buckminster Fuller). My later thinking involved the wheel owing to its simplicity.

Maintenance

The Carriage Wheel Ocean Turbine can be floated. It is anticipated that there will be roller and bearing wear, encrustation, seal failure, compressor malfunction, possible breakages, and general inspection requirements for all components. Seals and systems must be serviceable underwater, or removable and replaceable underwater. All roller wheels must be removable (43) together with their axles and bearings to facilitate topside maintenance or replacement. It will also be possible to access the moving carriage network by stopping the system with the target carriage at the top and performing work if the upper depth is within the range of divers or if capable submarines are available. It will be a challenge to make these operations safe.

Summary

The flow of water in the oceans is perhaps the greatest untapped source of energy available to man on the earth. Technology to unlock it must be developed if the world of the future is to serve the billions of people projected to exist then with a suitably developed lifestyle in an environmentally safe manner. Exhaustion or overuse of this resource, while possible, remains a distant danger. It is hoped that the Carriage Wheel Ocean Turbine will provide some furthering of this undertaking.

### DRAWINGS

### Reference Numerals

1. Tension Band
2. Track
3. Interconnecting cables
4. Carriages
5. Vanes
6. Trailing radial cables
7. Leading radial cables
8. Struts, triangular bracing
9. Turnbuckle
10. Hub
11. Boom
12. Roller support framework, down-current side
13. Rollers, large, high-compression bearings
14. Rollers, lateral, down-current side
15. Boom pivot pedestal
16. Rollers, inboard, up-current side
17. Yoke for interconnecting cable
18. Double-sliding I-beam connector
19. Axle and spool of interconnecting cables if used
20. Up-current lateral rollers
21. Hinges connecting down-current roller support framework to hull
22. Latches connecting down-current roller support framework to hull
23. Forward vane connector/spring hinge
24. After vane connector/spring hinge
25. Hull cross and x-bracing
26. Boom control system
27. Spring loaded opening axle
28. Up-current roller support framework
29. Hull
30. Track seam
31. Split-plug hermaphrodite connector
32. PVC interior mold/liner
33. Connection holes w/ smooth sleeves, recessed
34. Smooth sleeved holes for track interconnection mate of 40
35. Threaded mounting holes for strut brackets
36. Miscellaneous threaded mounting holes
37. Buoyancy control system access holes
38. Threaded mounting holes for strut brackets
39. Threaded mounting holes opposite end of 40
40. Threaded mounting holes/sleeves
41. (Not shown) Final connector split-plugs may require angular shave (interior-tangential) in order to fit.
42. Chamfer of split-plug ends
43. Removable-axle connector
44. Buoyancy system location—wheel
45. Buoyancy system location—carriage
46. Primary heavy-cable stays
47. Lateral stays
48. Dynamo housing location
49. bevel-gear housing, 90 degree rotation
50. Main mast
51. Anchor
52. Heliport and dock
53. Marker buoys
54. Wheel support masts
55. Upper wheel stays
56. Lower wheel stays
57. Extendable top stays (horizontal powered operation)
58. Extendable bottom stays (horizontal powered operation)
59. Retractable bottom stay (horizontal powered operation)
60. Diver service tower

I claim:

1. A large axial flow fluid-current motor intended for ocean power-generation
Comprising
(a) a minimum three-member trussed ring within and around which
(b) a network of interconnected rolling carriages each support
(c) a pair of cables which are connected to or pass through
(d) a center ring or shaft with attachment or pass-through hardware which in turn support
(e) an array of vanes maintained at an adjustable angle to the current passing over them.
(f) The said ring is constructed for modular assembly and maintenance under controlled-buoyancy conditions to be submerged, anchored, tethered and powered by stable mono-directional currents.
(g) Integration of tensile and compressive forces allows for minimal structural mass.
(h) Parts interchangeable while submerged facilitate maintenance.
(i) The said trussed ring contains a two-track inner ring pair triangularly braced by an outer tension ring.
(j) The said carriages have sets of wheels at each of four corners imprisoning them on the track and permitting simultaneous circular motion.
(k) There is a boom attached pivotably to the up-current-facing side which connects on the down-current side with a connector pivotably and double-slidably acting in relation to a fixed longitudinal member to attain adjustability of boom and thereby vane angle.
(l) The vanes are mounted on each of the said pairs of cables connected from each end of the boom to a center ring or axial shaft. The vanes will be acted upon by the current whereby urging the network of carriages, vanes, and cables to rotate.
(m) This rotational energy can be applied to dynamos mounted on a central shaft, at the perimeter, or aboard the individual carriages.

2. The fluid-current motor of claim 1 wherein said motor uses a friction-reducing method other than rolling wheels, or a combination of friction reduction methods. Magnetic levitation and/or forced water cushioning might achieve similar or superior friction reduction.

3. The fluid-current motor of claim 1 wherein said motor is not large and can therefore be substantially prefabricated prior to deployment and/or built without buoyancy controls.

4. The fluid-current motor of claim 1 wherein a multitude of such motors are arrayed in serial arrangement connected to a single central or peripheral driveshaft.

5. The fluid-current motor of claim 1 which is built in miniature as a toy or model.

6. The fluid-current motor of claim 1 wherein the said rings can be rotated pivotably and is self powered to induce aqueous current flow.

7. The fluid-current motor of claim 1 wherein a deployment mechanism is used to enable a measure of rotational freedom in a multi-directional current location.

8. The fluid-current motor of claim 1 in which the rigidity of the ring is provided by some means other than the trussing of three separate rings, eg. a spherical truss.

9. The fluid-current motor of claim 1 wherein support of the vanes is rigid upon the boom independent of cables or central connection.

10. The fluid-current motor of claim 1 wherein vane shape is altered from that depicted in the drawings.

11. The fluid-current motor of claim 1 wherein the entire ring and vane structure can rotate within a fixed friction-reducing clasp.
